(19) United States
(12) Patent Application Publication
(10) Pub. No.: US 2024/0172141 A1
(43) Pub. Date: May 23, 2024

(54) METHOD OF DEMODULATION REFERENCE SIGNAL INSERTION INTO TX IN-BAND EMISSION

(71) Applicant: MediaTek Singapore Pte. Ltd., Singapore (SG)

(72) Inventor: Jozsef Gabor Nemeth, Cambridge (GB)

(21) Appl. No.: 18/512,266

(22) Filed: Nov. 17, 2023

Related U.S. Application Data
(60) Provisional application No. 63/384,784, filed on Nov. 23, 2022.

(51) Int. Cl. H04W 52/36; H04B 17/336; H04L 5/00; H04L 27/26

(52) U.S. Cl. CPC H04W 52/367; H04B 17/336; H04L 5/0051; H04L 27/2614; H04W 52/365

(57) ABSTRACT

In an aspect of the disclosure, a method, a computer-readable medium, and an apparatus are provided. The apparatus may be a UE. In certain configurations, the UE transmits uplink data signals in a first bandwidth. The UE concurrently receives downlink data signals in a second bandwidth. The UE generates and transmits a reference signal in at least one of the second bandwidth and a bandwidth between the first bandwidth and the second bandwidth. The UE estimates a self-interference channel based on measurements of the reference signal. The UE cancels self-interference from the uplink transmission in the downlink data signals based on the estimated self-interference channel.

### CROSS-REFERENCE TO RELATED APPLICATION(S)

This application claims the benefits of U.S. Provisional Application Ser. No. 63/384,784, entitled “METHOD OF DEMODULATION REFERENCE SIGNAL INSERTION INTO TX IN-BAND EMISSION” and filed on Nov. 23, 2022, which is expressly incorporated by reference herein in their entirety.

### BACKGROUND

### Field

The present disclosure relates generally to communication systems, and more particularly, to techniques of methods and apparatuses for demodulation reference signal insertion into transmission (TX) in-band emission.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a UE. In certain configurations, the UE transmits uplink data signals in a first bandwidth. The UE concurrently receives downlink data signals in a second bandwidth. The UE generates and transmits a reference signal in at least one of the second bandwidth and a bandwidth between the first bandwidth and the second bandwidth. The UE estimates a self-interference channel based on measurements of the reference signal. The UE cancels self-interference from the uplink transmission in the downlink data signals based on the estimated self-interference channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example of transmission in-band emission of a SBFD UE.

FIG. 8 is a diagram illustrating examples of IBE bound in different carrier partition scenarios.

FIG. 9 is a diagram illustrating an example of a UE having a transmission antenna and

a reception antenna.

FIG. 10 is a diagram illustrating an example of superposing DMRS linearly onto the transmission in-band emission.

FIG. 11 is a diagram illustrating an example of regenerating DMRS in the FFT-domain after the CFR.

FIG. 12 is a flow chart of a method (process) for wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

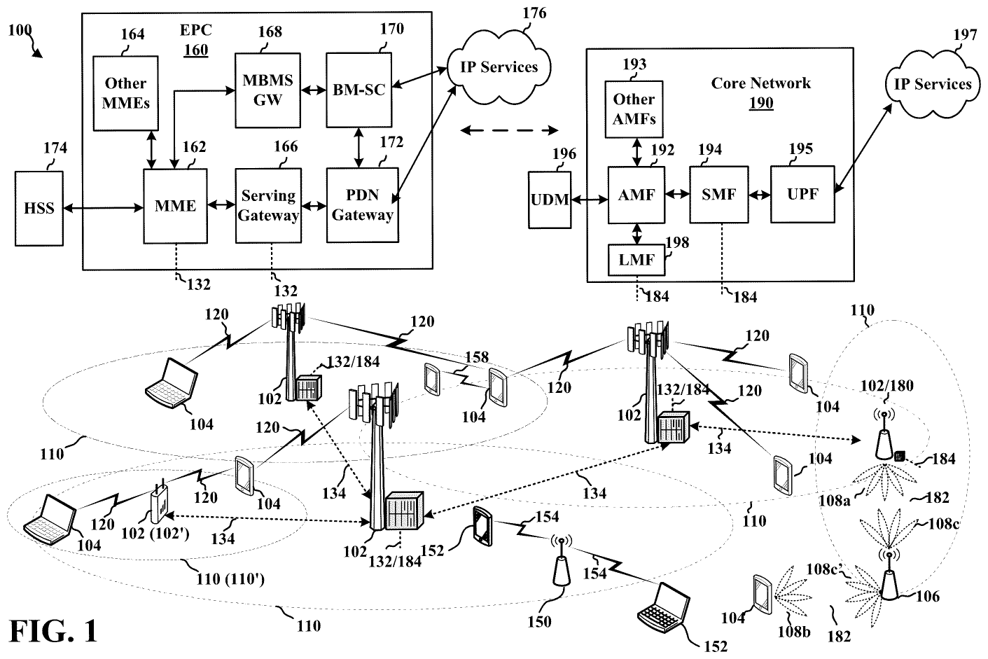

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHZ (e.g., 5, 10, 15, 20, 100, 400, etc. MHZ) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102″ may employ NR and use the same 5 GHZ unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW/near mmW radio frequency band (e.g., 3 GHZ-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

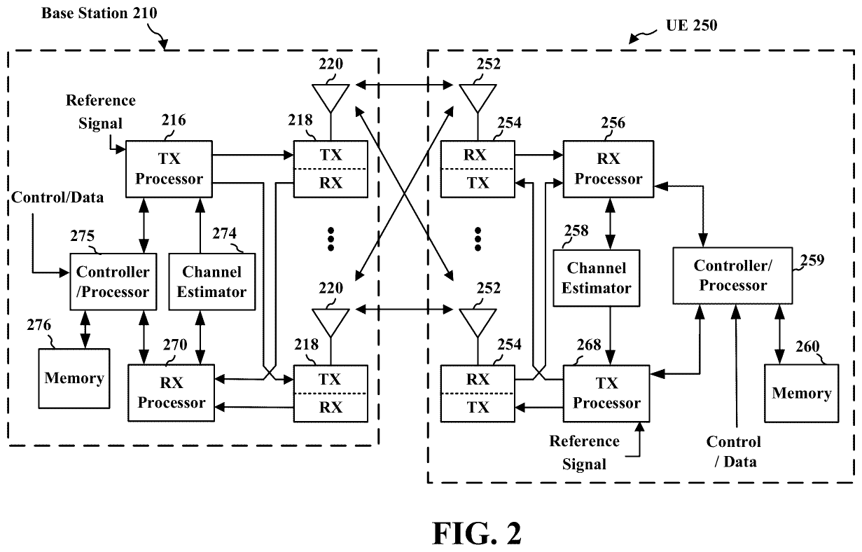

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting: PDCP layer functionality associated with header compression/decompression, security (ciphering, deciphering, integrity protection, integrity verification), and handover support functions: RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs: and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting: PDCP layer functionality associated with header compression/decompression, and security (ciphering, deciphering, integrity protection, integrity verification): RLC layer functionality associated with the transfer of upper layer PDUs, error correction through ARQ, concatenation, segmentation, and reassembly of RLC SDUs, re-segmentation of RLC data PDUs, and reordering of RLC data PDUs: and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

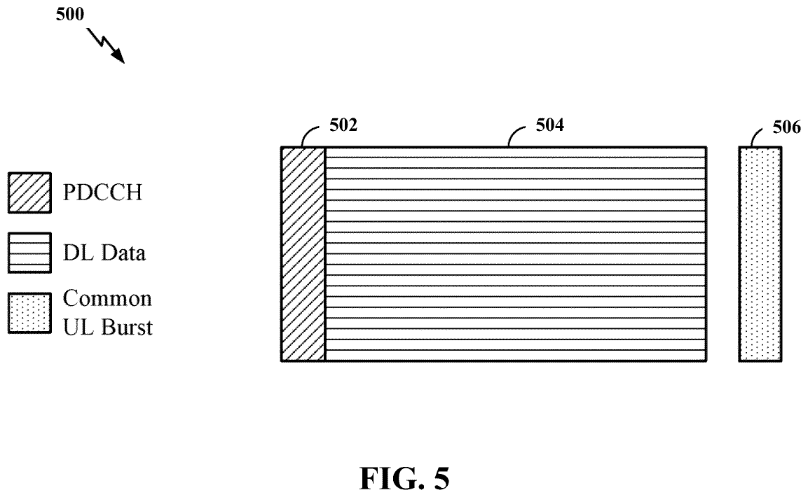

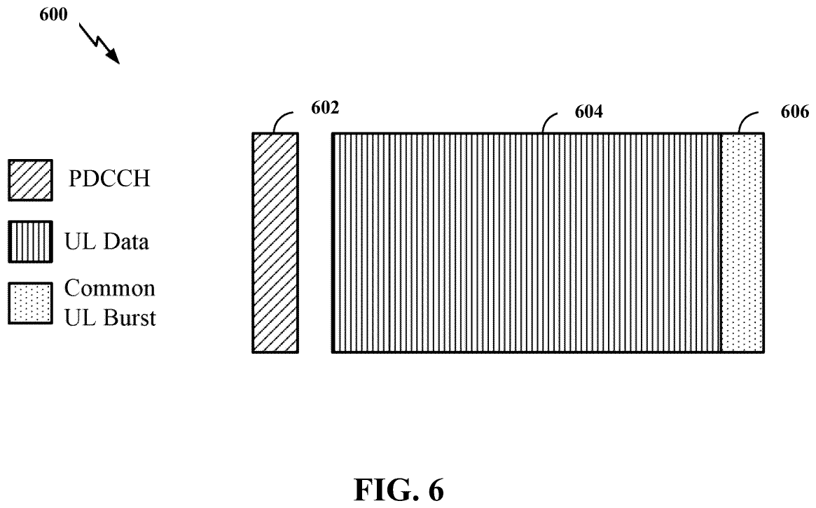

A single component carrier bandwidth of 100 MHZ may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

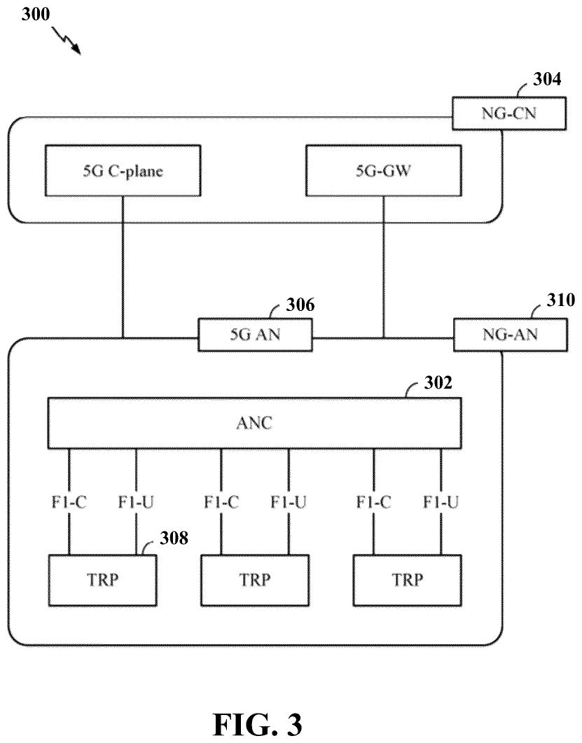

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

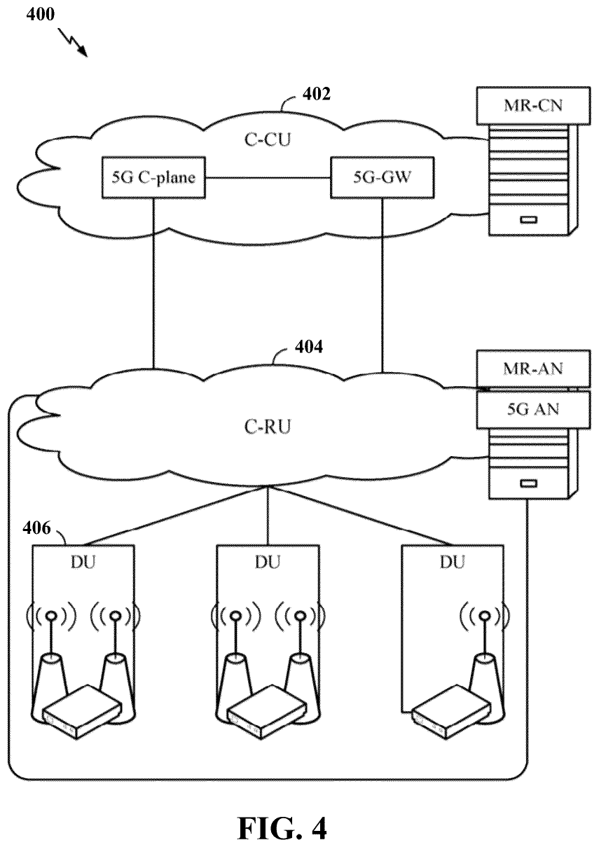

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

NR utilizes OFDM with a CP on the uplink and downlink and includes support for half-duplex operation using TDD. In certain configurations, concurrent transmission and reception within the same frequency band is not supported, due to the following issues: (1) Imperfect isolation of UL transmission signals from DL reception signals (and echoes): (2) The self-induced distortion issue, where high transmission signal level may block or saturate the receiver: (3) Self-interference issue, where non-linear leakage of the UL transmission contaminates the DL reception.

The primary issue is the self-interference, where uncompensated non-linear leakage is dependent on the transmission bandwidth and the frequency separation between UL and DL, among other parameters. Further, the compensation may also depend on the bandwidth and the frequency offset.

For a UE, particularly a subband full duplex (SBFD) UE within a single component carrier (CC) or a SBFD UE over unsynchronized TDD carriers intra-band, in the UE's prediction of the feasibility of full-duplex operation, the input parameters include: the bandwidth of the transmission signals, the bandwidth of the reception signals, and the frequency separation between the UL and DL signals.

To enable full-duplex operation, techniques are needed to address the self-interference issue. One approach is to insert reference signals, known as Demodulation Reference Signals (DMRS), into the transmit in-band emissions that fall within the bandwidth of the concurrent DL reception. The UE superimposes these DMRS signals linearly onto the existing transmit in-band emissions, boosting their power compared to the original TX IBE level. This allows faster convergence for the channel estimation, especially if a nonlinear model also needs to be tuned. It also assists in compensating for distortion such as intermodulation in the receiver.

The IBE DMRS patterns follow similar principles as existing reference signals like CSI-RS. They are known to the receiver, allowing it to estimate the channel and interference. The base station can configure the IBE DMRS to avoid collisions with scheduled DL data by restricting them to symbols/subcarriers configured as zero-power CSI-RS resources. After estimating the interference channel, the receiver can cancel the self-interference digitally.

To limit impacts on existing signals, the transmit IBE bound mask calculated with QPSK EVM can be observed when adding the IBE DMRS. The base station may also relax this bound through signaling. As an optimization, the IBE DMRS can avoid subcarriers expected to have IQ image or LO leakage, which could otherwise dominate the emission power.

When using crest factor reduction, the IBE DMRS may be regenerated after alteration to assist digital pre-distortion (DPD). As another optimization, harmonics generated during crest factor reduction can be suppressed where they would collide with DL DMRS positions.

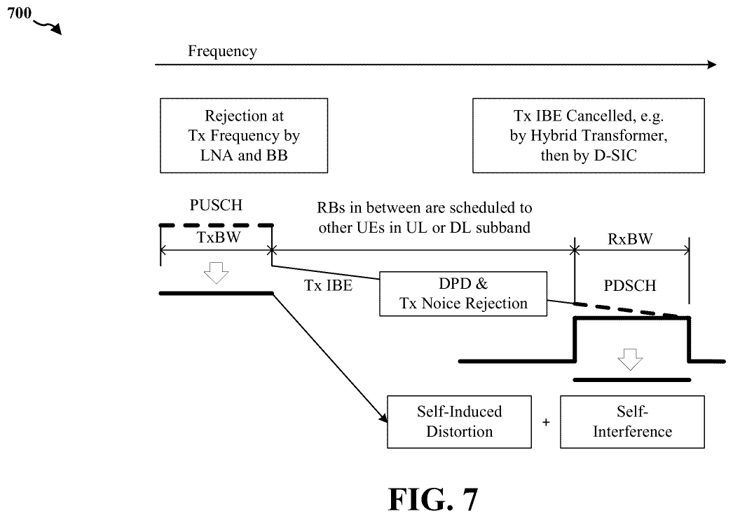

FIG. 7 is a diagram illustrating an example of transmission in-band emission of a SBFD UE. As shown in FIG. 7, the UE may perform an UL transmission (e.g., PUSCH) and a DL reception (e.g., PDSCH) at different frequency bandwidths. Specifically, the UE transmits the PUSCH in the transmission bandwidth (TxBW) and receives the PDSCH in the reception bandwidth (RxBW). The RBs in between the TxBW and the RxBW may be scheduled to other UEs in the UL or DL subband(s). Since the power of the UL transmission dominates the DL reception, the UL transmission generates a transmission IBE, which is an unwanted emission that starts higher at the transmission bandwidth TxBW and keeps decreasing through the frequency bandwidth between the UL transmission and the DL reception. Thus, it is desired that the transmission IBE may be attenuated to avoid overloading the receiver and affecting the DL reception.

DPD helps suppress the transmission in-band emissions (IBE) by pre-distorting the signal before the power amplifier to counteract the distortion caused by the power amplifier. This pushes the IBE down to some extent and prevents contamination of the downlink signal. DPD helps remove some of the harmonic components like Tx-IM (transmission intermodulation) on the transmitter side. Tx-IM refers to the spectral regrowth from the power amplifier compressing the signal peaks. However, DPD cannot fully eliminate all the harmonics. The remaining harmonics like Rx-IM, I/Q images, LO leakages can be further suppressed on the receiver side using D-SIC (digital successive interference cancellation).

The 3GPP NR specifications define a transmission IBE mask or bound that limits how much unwanted emission is allowed from the UE transmitter. The IBE mask is in dB difference between allocated and non-allocated RBs. This mask starts higher near the allocated RBs and goes down to a flat level (e.g. −30 dB) further away. The UE implements this mask in practice using DPD in the transmission chain. DPD pre-distorts the signal to counteract distortion from the power amplifier, which suppresses the IBE so it stays within the specified mask.

In certain configurations, rejection at the transmission frequency may be caused by a low noise amplifier (LNA) and baseband (BB), and the transmission IBE may be cancelled by the DPD and/or other means, e.g., by a hybrid transformer, then by a digital successive interference cancellation (D-SIC). However, once the transmission noise is suppressed, the transmission IBE may still include certain remaining parasitical signals that are harmonics, such as transmission intermodulation (Tx-IM), which is the transmission spectral regrowth from PA signal compression, reception intermodulation (Rx-IM) caused by LNA distortion, transmission in-phase/quadrature (I/Q) images induced from I/Q imbalance around the image frequency, and transmission carrier leakages at the local oscillator (LO) frequency, i.e., LO leakages. These harmonics may be suppressed partly on the transmission side (e.g., by the DPD) and partly on the reception side. For example, the receiver may run D-SIC and allow achieving interference cancellation enhancement in addition to the Tx-side compensation (e.g. the DPD in removing Tx-IM).

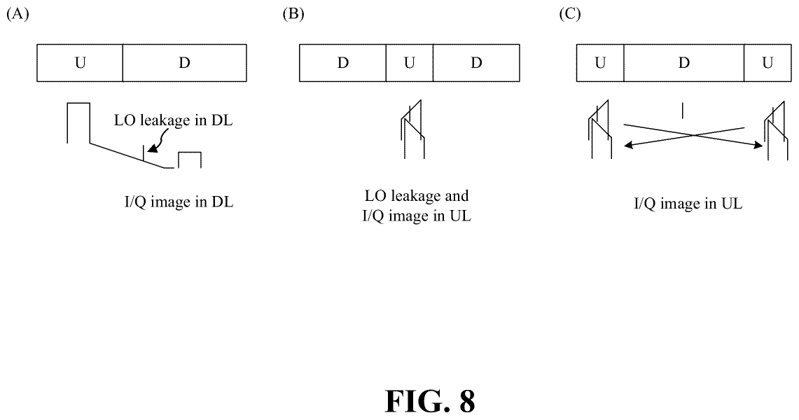

FIG. 8 shows examples of the in-band emission (IBE) bound in different carrier partition scenarios. All the scenarios refer to a single component carrier (CC) which is partitioned into multiple subbands.

FIG. 8(A) shows a downlink-uplink (DU) scenario where the CC is partitioned into two subbands—an uplink subband and a downlink subband. In the UL and DL spectrum, the UL transmission IBE includes a spike signal which corresponds to a carrier leakage (i.e. local oscillator or LO leakage). Further, an I/Q image, which is an attenuated image of the UL transmission spectrum, exists at the end of the IBE. As shown in FIG. 8(A), the carrier leakage (LO leakage) falls in the DL subband, and the I/Q image frequency overlaps with the DL subband.

FIG. 8(B) shows a downlink-uplink-downlink (DUD) scenario where the CC is partitioned into three subbands—a UL subband sandwiched between two DL subbands. Here, the DUD subbands are partitioned symmetrically, and the carrier leakage (LO leakage) and I/Q image fall within the UL subband. In other words, the I/Q image frequencies do not overlap with either of the DL subbands.

FIG. 8(C) shows an uplink-downlink-uplink (UDU) scenario where the CC is partitioned into three subbands—a DL subband sandwiched between two UL subbands. Again, the UDU subbands are partitioned symmetrically, and the I/Q images fall within the UL subbands, while the carrier leakage (LO leakage) falls within the DL subband. The I/Q image frequencies do not overlap with either of the DL subbands.

With symmetrical DUD or UDU partitioning, the I/Q image frequencies do not overlap with the DL subband(s). In the contrary case (e.g. DU scenario in FIG. 8(A)), the self-interference channel may need to be estimated for I/Q imbalance compensation. On the other hand, the carrier leakage frequency can fall in the UL subband (e.g. DUD scenario in FIG. 8(B)) or at least outside the DL signal resource blocks (RBs). In the contrary case (e.g. DU scenario in FIG. 8(A) or UDU scenario in FIG. 8(C)), the leakage subcarrier can either be punctured or cancelled after estimating the self-interference channel.

Additionally, the reception-side Tx-IM (transmission intermodulation) compensation requires estimation of a considerable number of power amplifier (PA) model parameters besides the self-interference channel. It should be noted that the transmission-side suppression does not require the self-interference channel. However, the transmission-side suppression can be more challenging than the reception-side cancellation from aspects like forward/observation linearity, loop delay, DAC ENOB limitation etc. Only the digital receiver can compensate for the LNA distortion or spectrum products of crest factor reduction (CFR).

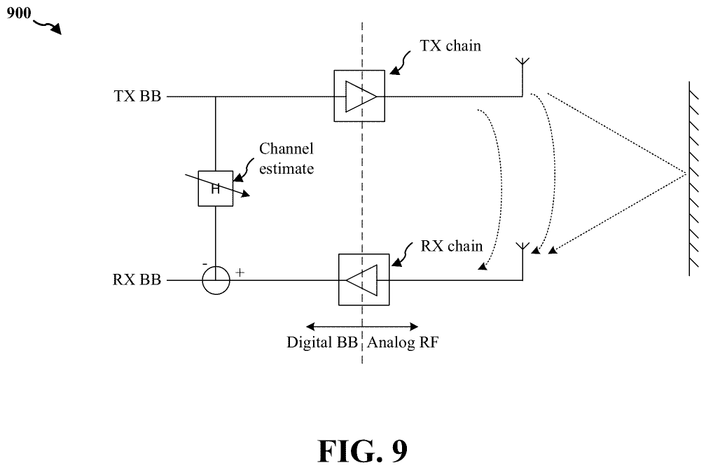

FIG. 9 illustrates an example of a UE with separate transmit and receive antennas. The UE 900 includes two antennas, one for transmission and one for reception, each with its own corresponding TX/RX chain of circuits (e.g. power amplifier, D/A or A/D converters, etc.). There can be some direct interference path between the two antennas, as well as indirect paths (echoes) due to reflections from surrounding objects. To enable cancellation of the self-interference, a channel estimate is made between the TX and RX chains to model the direct and indirect interference paths. For example, a gradient descent algorithm can adapt weights over uniform time lags to minimize the MSE between the filtered TX signal and the RX signal input. The TX IBE within the RX signal bandwidth is also used as an input to the channel adaptation.

In some cases, the transmission IBE level may be much weaker than the TX signal, potentially 50 dB lower. This leaves a large headroom compared to the TX IBE bound flat region specified in 3GPP, such as −30 dBm/MHz. To take advantage of this headroom, reference signals such as IBE Demodulation Reference Signals (DMRS), or other similar reference signals (RSS), are linearly superimposed onto the existing TX IBE, especially in the concurrent DL reception bandwidth. This boosts the power of the IBE DMRS compared to the original TX IBE level. With the higher powered IBE DMRS, the channel estimation can converge faster, which is useful when a nonlinear model also needs to be estimated or Rx-IM distortion is present. In one embodiment, the nonlinear model parameters are estimated separately from the channel, improving accuracy and convergence time.

The IBE DMRS patterns follow similar principles as existing UL DMRS or DL DMRS. The patterns are known at the receiver, enabling channel estimation. To avoid collisions with scheduled DL data, the gNB can restrict IBE DMRS to symbols or subcarriers configured as zero-power CSI-RS resources, where no DL data is mapped. After estimating the interference channel, the receiver can cancel the self-interference digitally through techniques like successive interference cancellation.

To limit impact on existing signals, the transmit IBE mask calculated for QPSK EVM can be observed when adding IBE DMRS. The gNB may also relax this bound through signaling. As an optimization, the IBE DMRS can avoid subcarriers expected to have IQ image or LO leakage, which could otherwise dominate the emission power.

When using crest factor reduction (CFR), the IBE DMRS may need to be regenerated after alteration by CFR to assist digital pre-distortion. As another optimization, harmonics generated by CFR can be suppressed where they would collide with DL DMRS positions.

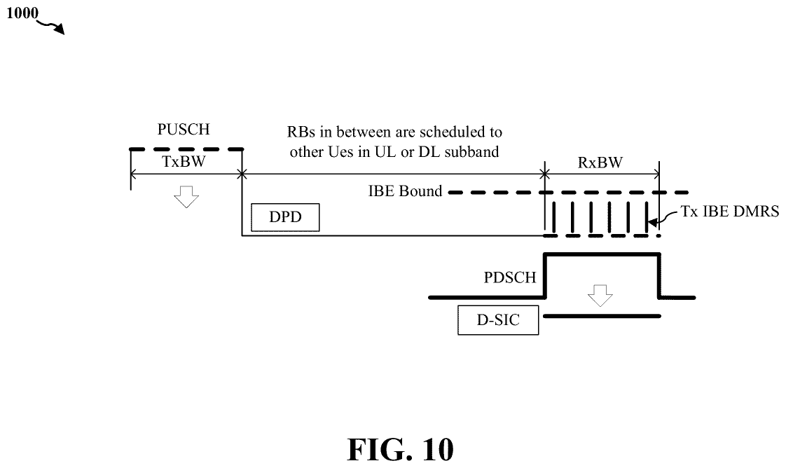

FIG. 10 illustrates an example of linearly superposing DMRS onto the transmission in-band emission. As shown in FIG. 10, the IBE bound is below the power density of the UL transmission (i.e., the PUSCH). When the transmission IBE is suppressed (e.g., by the DPD) and is below the IBE bound, there is a headroom between the IBE bound and the suppressed transmission IBE. The UE may linearly superpose/insert the reference signals (e.g., the transmission IBE DMRS) onto the transmission IBE in order to compensate for or cancel the self-interference.

In one example, after DPD, the interference power from the uplink transmission that leaks into the downlink receiver's band is around 50 dB below the uplink transmit power level. However, the regulatory out-of-band emission limit specified in the 3GPP standard allows the interference power to go as high as −30 dB relative to the uplink transmit power spectral density. So there is around 20 dB of headroom between the current interference level of −50 dB and the maximum permissible level of −30 dB.

Even if there is only 5 dB of headroom, there is some allowable gap between the present interference caused by the uplink transmit signal and the maximum out-of-band emission limit as per the standard. This headroom can be leveraged to insert additional pilot tones (e.g., IBE DMRS) on specific symbols and subcarriers in the uplink transmission, without violating the standard or causing excessive interference to other UEs' downlink reception.

These pilot tones boosts the received signal power, allowing for more accurate estimation of the interference channel at the downlink receiver. This improves the receiver's ability to cancel out the self-interference.

The UE selects an appropriate target interference level after adding IBE DMRS, based on the channel estimation and interference cancellation needs while remaining within the available headroom. The IBE DMRS transmission power is set such that the resulting interference density after adding the IBE DMRS matches this pre-determined target level. By staying within the headroom budget, the IBE DMRS density is optimized to provide just enough boosted interference for reliable channel estimation, without exceeding regulatory limits.

The TX IBE DMRS signals are inserted by the UE transmitter into the DL RxBW and/or the bandwidth between the UL TxBW and the DL RxBW. The UE transmitter can transmit signals in the DL RxBW.

In one embodiment, the IBE DMRS is only added within the bandwidth of the concurrent DL reception, as shown in FIG. 10. In an alternative embodiment, the IBE DMRS may also be added in different frequency regions, e.g., for assisting cross-link interference cancellation by other UEs. For example, another UE may be receiving in a different frequency region, and inserting IBE DMRS in that region could help that UE estimate and cancel the interference from this transmitting UE. So the IBE DMRS can potentially assist with cross-link interference mitigation by inserting reference signals in frequency regions used by victim UEs.

In one embodiment, the transmission IBE mask is determined on a per-RB transmission IBE level by the 3GPP specifications. In a further embodiment, the transmission IBE mask is calculated with a Quadrature Phase Shift Keying (QPSK) error vector magnitude (EVM) bound. The IBE mask sets a limit on the maximum allowed in-band emissions for a transmission, as a function of frequency offset. This limit is higher for lower order modulations like QPSK, and lower for higher order modulations like 64QAM. For low modulation like QPSK, the transmission is assumed to be at the cell edge, so its emissions cause less interference to others. For 64QAM, the transmission is typically closer to the base station, so its emissions can cause more interference. Hence a tighter IBE mask. According to the present disclosure, the TX IBE DMRS power is referenced to the QPSK IBE mask, regardless of the actual modulation being used. This “decouples” it from the modulation scheme and provides a looser IBE mask that gives more headroom for the TX IBE DMRS.

In another embodiment, the transmission IBE mask may be relaxed based on signaling from the base station. For example, the base station may configure the transmission IBE bound at a higher value, allowing higher power for the IBE DMRS. The base station can signal to the UE to relax or increase this IBE mask, allowing the UE to transmit at higher power densities in the non-allocated regions. This would provide more headroom for the UE to boost the power of the IBE DMRS that are superimposed on the transmission IBE. With higher powered DMRS, the channel estimation at the receiver can converge faster and more accurately.

In one embodiment, the IBE DMRS is added only in pre-defined or configured symbol positions. In another embodiment, the IBE DMRS is added only in pre-defined or configured subcarrier positions. For example, the UE may insert the IBE DMRS in specific symbols within the transmission bandwidth. For example, the IBE DMRS could be inserted in every 4th symbol. The symbol positions are known by the transmitter and receiver. Further, the IBE DMRS may be allocated to specific subcarriers in the frequency domain. For example, the IBE DMRS could be inserted every 6 subcarriers. Again, the subcarrier positions are known by both transmitter and receiver. By restricting the IBE DMRS to only certain symbol positions or subcarrier positions, the interference to existing signals can be limited. Collision with downlink data resources is also avoided through this technique. The IBE DMRS may avoid overlapping with the expected positions of downlink DMRS. For example, if the known pattern of downlink DMRS is present in certain symbol positions or subcarriers of the downlink PDSCH signal, then the IBE DMRS is carefully positioned in symbols/subcarriers that do not collide with the downlink DMRS.

In one embodiment, the IBE DMRS is added only in symbols or subcarrier positions where the gNB (base station) configures zero power channel state information reference signals (ZP-CSI-RS). The ZP-CSI-RS corresponds to measurement resources of zero power to prevent collision between the downlink signal and the IBE DMRS. In one embodiment, the ZP-CSI-RS pattern is signaled by the base station to the UE to define the IBE DMRS symbol/subcarrier positions without downlink signals.

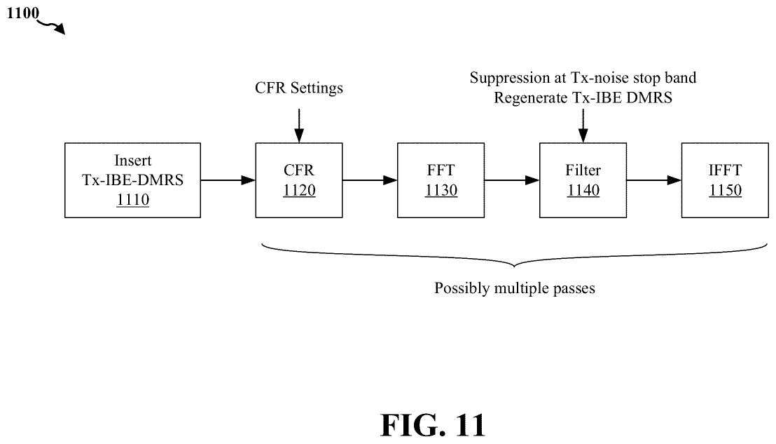

FIG. 11 is a diagram illustrating an example process of regenerating DMRS in the FFT-domain after the CFR. Specifically, when the DPD is applied (see FIG. 10) to suppress the transmission noise, the CFR may be added in combination with the DPD. In the example process 1100 as shown in FIG. 11, the CFR is applied after the insertion of the IBE DMRS and before the DPD process. At operation 1110, the UE maps the IBE DMRS to configured resources and generates a time domain signal. At operation 1120, the UE performs the CFR 1220 with configured CFR settings to the time-domain waveform that now contains the IBE DMRS. The CFR attenuates the peak amplitudes in the time-domain signal to improve the peak-to-average power ratio. However, this distortion in the time-domain also distorts the IBE DMRS signals that were inserted.

At operation 1130, to recover the IBE DMRS, the signal goes through Fast-Fourier-Transform (FFT) to transform to the frequency domain. The frequencies corresponding to the TX IBE DMRS are identified. At operation 1140, the harmonics go through a filtering process for spectrum shaping purposes, in which side band emissions created by the CFR is controlled/suppressed at the transmission-noise stop band. Further, the harmonics at the IBE DMRS positions (which has been altered by the CFR at operation 1120) are regenerated, for example, by boosting or recovering the distorted TX IBE DMRS frequency components (harmonics) based on their originally transmitted values. This regeneration at the FFT stage helps recover the TX IBE DMRS that were distorted by CFR in the time domain. In one embodiment, the regeneration of the IBE DMRS is limited to, e.g., 3 dB below the original level.

At operation 1150, the filtered harmonics go through an inversed FFT (IFFT) process to be transformed back to the time domain, and the result may be forwarded to the DPD for further processing.

In certain configurations, the filtering process at operation 1140 may overly attenuate the magnitudes of the output of the CFR at operation 1120, such that the output at the end of the operation 1150 is not satisfactory. In this case, the operations 1120 to 1150 may be performed with multiple passes to gradually reduce the peak-to-average power ratio while maintaining sufficient power in the wanted signal.

In one embodiment, the harmonics generated by the CFR are suppressed in the FFT domain at positions where the harmonics would collide with a downlink DMRS from the base station. Specifically, the downlink reception (e.g., the PDSCH as shown in FIG. 11) from the base station may include downlink signals and downlink DMRS. By suppressing the CFR harmonics at positions where a downlink DMRS is expected, collision between the CFR harmonics and the downlink DMRS can be avoided. After FFT, the UE may directly set the values of the colliding frequency bins to zero. For example, if bin 5, 10 and 15 collide with DL DMRS, the UE sets those bin values to zero. In one embodiment, the suppression of the harmonics is limited to, e.g., 3 dB below the original level. In the frequency domain, the UE regenerates the expected harmonic signal at the colliding frequencies but limit its power. For example, the UE regenerate bins 5, 10 and 15 but limit the amplitude to 3 dB below the original power.

In one embodiment, no DMRS is inserted at one or more subcarriers where the I/Q image or the LO leakage is expected. Specifically, the emission power of the I/Q image or the LO leakage may already be high, so if the IBE DMRS is inserted at the position(s) where the I/Q image or LO leakage is expected, the IBE DMRS may be dominated by the I/Q image or LO leakage. Alternatively, the IBE DMRS may require higher power compared to other positions to dominate over the I/Q image or LO leakage in order to be effective. Thus, it may be desirable to arrange the IBE DMRS insertion to avoid overlapping with the expected I/Q image and/or LO leakage positions.

The local oscillator signal can leak into the transmission chain, resulting in a high-power tone at a specific subcarrier frequency in the transmit in-band emissions (IBE) spectrum. The local oscillator leakage and I/Q image tones can result in high-power spectral components at specific predictable subcarriers in the transmit in-band emissions. If the IBE DMRS pilot tones are inserted on top of these subcarriers occupied by LO leakage or I/Q images, the high-power spectral components would overwhelm the pilot tones. The pilots would be dominated and rendered ineffective for channel estimation.

To be useful, the IBE DMRS pilots need adequate power to be reliably detectable at the receiver. But boosting pilot power significantly above the LO leakage or I/Q image power could cause excessive interference to downlink reception.

Therefore, it is optimal to avoid allocating IBE DMRS pilots at subcarriers where LO leakage or I/Q images are expected. The known patterns of these components can directly assist the channel estimation process. The IBE DMRS pilots are better inserted at other subcarriers to aid channel estimation without high power requirements.

By avoiding superposition of IBE DMRS pilots where LO leakage or I/Q images are expected, the pilots achieve better effectiveness. At the same time, interference is minimized by eliminating the need to boost pilot power markedly above the high-power spectral components already occupying those subcarriers.

Further, the receiver at the UE first extracts the received IBE DMRS symbols that were transmitted by the UE in the uplink band. Since the IBE DMRS patterns are known a priori, the receiver can estimate the characteristics of the interference channel based on the received IBE DMRS symbols. This provides an estimate of the multipath channel that the unintended UE transmission signals propagate through between the UE's transmit chain and the receiver.

The receiver has access to the original UE uplink transmissions, such as the PUSCH signals, that are causing interference and distortion. Using the known original PUSCH signals and the estimated interference channel, the receiver can reconstruct estimated versions of the interference and distortion components arising from the UE's uplink transmission. This modeling provides a close match to the actual interference and distortion corrupting the desired downlink signal.

The receiver then subtracts this estimated interference and distortion waveform from the received downlink signal. This interference cancellation technique, enabled by the IBE DMRS channel estimation, effectively removes the contamination arising from the UE's uplink transmissions. This leaves behind a cleaner downlink signal with reduced interference, allowing more reliable demodulation and decoding of the downlink data. By applying the channel model to the known uplink signal, the receiver can reconstruct and subtract out the resulting interference, thereby improving the downlink signal quality.

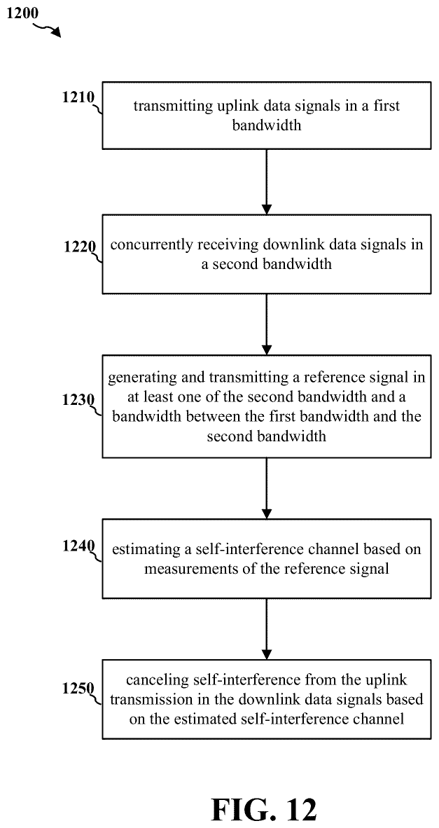

FIG. 12 is a flow chart of a method (process) for wireless communication of a UE. The method may be performed by a UE (e.g., the UE 900). At operation 1210, the UE transmits uplink data signals in a first bandwidth. At operation 1220, the UE concurrently receives downlink data signals in a second bandwidth. At operation 1230, the UE generates and transmits a reference signal in at least one of the second bandwidth and a bandwidth between the first bandwidth and the second bandwidth. At operation 1240, the UE estimates a self-interference channel based on measurements of the reference signal. At operation 1250, the UE cancels self-interference from the uplink transmission in the downlink data signals based on the estimated self-interference channel.

In certain configurations, in the operation 1230, the UE transmits the reference signal at a selected transmission power density such that a reception power density of the reference signal is within a specified headroom below a regulatory transmission in-band emission limit. The regulatory transmission in-band emission limit may be calculated with a QPSK EVM bound.

In certain configurations, in the operation 1230, the UE generates a first waveform in a time domain carrying the reference signal. The UE applies CFR to the first wave form. The UE transforms the first waveform after the CFR to one or more frequency components in a frequency domain. The UE identifies, from the one or more frequency components, frequency components corresponding to the reference signal in the frequency domain. The UE regenerates the identified frequency components in accordance with the reference signal. The UE transforms the one or more frequency components including the regenerated frequency components into a second waveform in the time domain. In certain configurations, the UE regenerates the identified frequency components by boosting or recovering the identified frequency components based on an original value of the reference signal. In certain configurations, the UE suppresses the one or more frequency components in the frequency domain at a position where the one or more frequency components collide with a demodulation reference signal in the downlink data signals.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
transmitting uplink data signals in a first bandwidth;
concurrently receiving downlink data signals in a second bandwidth;
generating and transmitting a reference signal in at least one of the second bandwidth and a bandwidth between the first bandwidth and the second bandwidth;
estimating a self-interference channel based on measurements of the reference signal; and
canceling self-interference from the uplink transmission in the downlink data signals based on the estimated self-interference channel.

2. The method of claim 1, wherein the generating and transmitting the reference signal comprises transmitting the reference signal at a selected transmission power density such that a reception power density of the reference signal is within a specified headroom below a regulatory transmission in-band emission limit.

3. The method of claim 2, wherein the regulatory transmission in-band emission limit is calculated with a Quadrature Phase Shift Keying (QPSK) error vector magnitude (EVM) bound.

4. The method of claim 1, wherein the generating and transmitting the reference signal comprises:
generating a first waveform in a time domain carrying the reference signal;
applying crest factor reduction (CFR) to the first waveform;
transforming the first waveform after the CFR to one or more frequency components in a frequency domain;
identifying, from the one or more frequency components, frequency components corresponding to the reference signal in the frequency domain;
regenerating the identified frequency components in accordance with the reference signal; and
transforming the one or more frequency components including the regenerated frequency components into a second waveform in the time domain.

5. The method of claim 4, wherein the regenerating the identified frequency components comprises boosting or recovering the identified frequency components based on an original value of the reference signal.

6. The method of claim 4, further comprising:
suppressing the one or more frequency components in the frequency domain at a position where the one or more frequency components collide with a demodulation reference signal in the downlink data signals.

7. The method of claim 1, wherein the reference signal is a demodulation reference signal (DMRS).

8. The method of claim 7, wherein the DMRS is transmitted in pre-defined or configured symbol positions or subcarrier positions.

9. The method of claim 7, wherein the DMRS is transmitted in one or more symbol or subcarrier positions where a base station configures zero power channel state information (CSI) reference signals.

10. The method of claim 9, further comprising:
receiving, from the base station, a zero power CSI reference signal pattern defining configurations of the one or more symbol or subcarrier positions.

11. The method of claim 7, wherein the DMRS is not transmitted in one or more subcarriers where an in-phase/quadrature (I/Q) image or a local oscillator (LO) leakage is expected.

12. An apparatus for wireless communication, the apparatus being a user equipment (UE), comprising:
a memory; and
at least one processor coupled to the memory and configured to:
transmit uplink data signals in a first bandwidth;
concurrently receive downlink data signals in a second bandwidth;
generate and transmit a reference signal in at least one of the second bandwidth and a bandwidth between the first bandwidth and the second bandwidth;
estimate a self-interference channel based on measurements of the reference signal; and
cancel self-interference from the uplink transmission in the downlink data signals based on the estimated self-interference channel.

13. The apparatus of claim 12, wherein the at least one processor is configured to generate and transmit the reference signal by transmitting the reference signal at a selected transmission power density such that a reception power density of the reference signal is within a specified headroom below a regulatory transmission in-band emission limit.

14. The apparatus of claim 13, wherein the regulatory transmission in-band emission limit is calculated with a Quadrature Phase Shift Keying (QPSK) error vector magnitude (EVM) bound.

15. The apparatus of claim 12, wherein the at least one processor is configured to generate and transmit the reference signal by:
generating a first waveform in a time domain carrying the reference signal;
applying crest factor reduction (CFR) to the first waveform;
transforming the first waveform after the CFR to one or more frequency components in a frequency domain;
identifying, from the one or more frequency components, frequency components corresponding to the reference signal in the frequency domain;
regenerating the identified frequency components in accordance with the reference signal; and
transforming the one or more frequency components including the regenerated frequency components into a second waveform in the time domain.

16. The apparatus of claim 15, wherein the at least one processor is further configured to:
suppress the one or more frequency components in the frequency domain at a position where the one or more frequency components collide with a demodulation reference signal in the downlink data signals.

17. The apparatus of claim 12, wherein the reference signal is a demodulation reference signal (DMRS).

18. The apparatus of claim 17, wherein the DMRS is transmitted in pre-defined or configured symbol positions or subcarrier positions.

19. The apparatus of claim 17, wherein the DMRS is transmitted in one or more symbol or subcarrier positions where a base station configures zero power channel state information (CSI) reference signals.

20. The apparatus of claim 19, wherein the at least one processor is further configured to:
receive, from the base station, a zero power CSI reference signal pattern defining configurations of the one or more symbol or subcarrier positions.
